(19) United States
(12) Patent Application Publication
(10) Pub. No.: US 2023/0244313 A1
(43) Pub. Date: Aug. 3, 2023

(54) INFORMATION PROCESSING APPARATUS, TACTILE SENSE PROVIDING SYSTEM, AND PROGRAM

(71) Applicant: Sony Group Corporation, Tokyo (JP)

(72) Inventors: Tsuyoshi ISHIKAWA, Kanagawa (JP); Jun KIMURA, Kanagawa (JP); Shinichi KAWANO, Tokyo (JP); Ikuo YAMANO, Tokyo (JP); Keijiroh NAGANO, Tokyo (JP)

(73) Assignee: Sony Group Corporation, Tokyo (JP)

(21) Appl. No.: 18/015,630

(22) PCT Filed: Jul. 19, 2021
(86) PCT No.: PCT/JP2021/026982

§ 371 Date: Jan. 11, 2023

(30) Foreign Application Priority Data
Jul. 30, 2020 (JP) 2020-129360

(51) Int. Cl. G06F 3/01

(52) U.S. Cl. CPC G06F 3/014; G06F 3/016

(57) ABSTRACT

There is provided an information processing apparatus, a tactile sense providing system, and a program that are intended for a real object and make it possible to provide a tactile sense. The information processing apparatus according to the present technology includes a real object detector, a body part detector, and a drive signal generator. The real object detector detects a real object. The body part detector detects a position and a pose of a part of a body. The drive signal generator generates a drive signal on the basis of a positional relationship between the real object and the part, the drive signal being supplied to a tactile sense providing mechanism that is worn on the part.

### TECHNICAL FIELD

The present technology relates to an information processing apparatus, a tactile sense providing system, and a program that are used to provide a tactile sense to a user.

### BACKGROUND ART

When a realistic tactile sense is provided by a real object being used upon practicing or playing, this results in a greater effect of a training or in a greater pleasure. For example, when a realistic tactile sense, such as a tactile sense of simmering that is obtained upon touching a toy pot or a grainy tactile sense from scales that is obtained upon touching the surface of a toy fish, is provided for each toy upon playing by pretending to cook, this results in improving a quality of experience.

For example, Patent Literature 1 discloses an oscillation providing device that is worn on a hand of a user. The oscillation providing device includes an oscillation actuator provided to a portion, in the oscillation providing device, that is brought into contact with a finger or a wrist of a user, and can cause a simulated tactile sense to occur by the oscillation actuator oscillating when the finger or the wrist is brought into contact with a virtual object in a virtual reality (VR) space.

### CITATION LIST

### Patent Literature

Patent Literature 1: WO 2018/092595

### DISCLOSURE OF INVENTION

### Technical Problem

As described above, the oscillation providing device disclosed in Patent Literature 1 is intended for a virtual object, but is not intended for a real object.

In view of the circumstances described above, it is an object of the present technology to provide an information processing apparatus, a tactile sense providing system, and a program that are intended for a real object and make it possible to provide a tactile sense.

### Solution to Problem

In order to achieve the object described above, an information processing apparatus according to an embodiment of the present technology includes a real object detector, a body part detector, and a drive signal generator.

The real object detector detects a real object.

The body part detector detects a position and a pose of a part of a body.

The drive signal generator generates a drive signal on the basis of a positional relationship between the real object and the part, the drive signal being supplied to a tactile sense providing mechanism that is worn on the part.

According to this configuration, a tactile sense that is not obtained from a real object alone can be provided to a user according to a positional relationship between the real object and a part on which the tactile sense providing mechanism is worn, and thus the reality and the accuracy, or enjoyable different tactile senses can be provided to the user.

The real object detector may determine a type of the real object, and
the drive signal generator may generate the drive signal further according to the type.

The drive signal generator may determine whether the real object and the part are in contact with each other, on the basis of the positional relationship between the real object and the part, and may generate the drive signal according to a result of the determination.

When the part is brought into contact with the real object, the drive signal generator may generate the drive signal such that the tactile sense providing mechanism causes a tactile sense to occur.

The drive signal generator may generate the drive signal according to a force of pressing performed by the part on the real object.

When the part is moved with respect to the real object in a state in which the part is in contact with the real object, the drive signal generator may generate the drive signal such that the tactile sense providing mechanism causes a tactile sense to occur.

The drive signal generator may generate the drive signal according to at least one of a distance or a speed of movement of the part with respect to the real object.

When the real object and the part are moved in a state of remaining in contact with each other, the drive signal generator may generate the drive signal such that the tactile sense providing mechanism causes a tactile sense to occur.

The drive signal generator may generate the drive signal according to at least one of a distance or a speed of movement of the real object.

The drive signal generator may generate the drive signal according to a portion, in the real object, with which the specific part is in contact.

The drive signal generator may determine whether a first object and a second object are in contact with each other, the first object being an object of which a position relative to the part is fixed, the second object being an object of which a position relative to the part is not fixed,
the drive signal generator may generate the drive signal according to a result of the determination, and
at least one of the first object or the second object may be the real object.

The first object and the second object may be the real objects.

The information processing apparatus may further include a virtual object generator that generates a virtual object in a real space,
the first object may be the real object, and
the second object may be the virtual object.

The information processing apparatus may further include a virtual object generator that generates a virtual object in a real space,
the first object may be the virtual object, and
the second object may be the real object.

The drive signal generator may generate the drive signal according to at least one of a distance or a speed of movement of a point of contact of the first object and the second object.

The part may be a hand, and
the body part detector may detect a position and a pose of the hand on the basis of output from a sensor that is worn on the hand.

The information processing apparatus may further include an object information acquiring section that acquires information related to the real object, and
the drive signal generator may generate the drive signal further according to the information.

The tactile sense providing mechanism may be an oscillation generation mechanism that is capable of generating oscillation, and
the drive signal generator may generate, as the drive signal, a waveform of the oscillation generated by the oscillation generation mechanism.

In order to achieve the object described above, a tactile sense providing system according to an embodiment of the present technology includes a tactile sense providing mechanism and an information processing apparatus.

The tactile sense providing mechanism is worn on a part of a body.

The information processing apparatus includes
a real object detector that detects a real object,
a body part detector that detects a position and a pose of the part, and
a drive signal generator that generates a drive signal on the basis of a positional relationship between the real object and the part, the drive signal being supplied to the tactile sense providing mechanism.

In order to achieve the object described above, a program according to an embodiment of the present technology causes an information processing apparatus to operate as a real object detector, a body part detector, and a drive signal generator.

The real object detector detects a real object.

The body part detector detects a position and a pose of a part of a body.

The drive signal generator generates a drive signal on the basis of a positional relationship between the real object and the part, the drive signal being supplied to a tactile sense providing mechanism that is worn on the part.

### BRIEF DESCRIPTION OF DRAWINGS

FIG. 1 is a block diagram of a tactile sense providing system according to embodiments of the present technology.

FIG. 2 schematically illustrates a controller included in the tactile sense providing system.

FIG. 3 schematically illustrates an arrangement of a sensor section and a tactile sense providing mechanism that are included in the controller.

FIG. 4 schematically illustrates AR glasses included in the tactile sense providing system.

FIG. 5 schematically illustrates a specific part that is detected by a body part detector included in the control section of the AR glasses.

FIG. 6 schematically illustrates a real object that is detected by a real object detector included in the control section of the AR glasses.

FIG. 7 is a flowchart illustrating an operation of the tactile sense providing system.

FIG. 8 is a schematic diagram illustrating the operation of the tactile sense providing system.

FIG. 9 is a schematic diagram illustrating the operation of the tactile sense providing system.

FIG. 10 is a schematic diagram illustrating the operation of the tactile sense providing system.

FIG. 11 is a schematic diagram illustrating the operation of the tactile sense providing system.

FIG. 12 is a schematic diagram illustrating the operation of the tactile sense providing system.

FIG. 13 is a schematic diagram illustrating the operation of the tactile sense providing system.

FIG. 14 is a schematic diagram illustrating the tactile sense providing system in Operation Example 1-1.

FIG. 15 is a schematic diagram illustrating the tactile sense providing system in Operation Example 1-2.

FIG. 16 is a schematic diagram illustrating the tactile sense providing system in Operation Example 1-3.

FIG. 17 is a schematic diagram illustrating the tactile sense providing system in Operation Example 1-4.

FIG. 18 is a schematic diagram illustrating the tactile sense providing system in Operation Example 2-1.

FIG. 19 is a schematic diagram illustrating the tactile sense providing system in Operation Example 2-2.

FIG. 20 is a schematic diagram illustrating the tactile sense providing system in Operation Example 2-3.

FIG. 21 is a schematic diagram illustrating the tactile sense providing system in Operation Example 3-1.

FIG. 22 is a schematic diagram illustrating the tactile sense providing system in Operation Example 3-2.

FIG. 23 is a schematic diagram illustrating the tactile sense providing system in Operation Example 3-3.

FIG. 24 is a schematic diagram illustrating the tactile sense providing system in Operation Example 3-4.

FIG. 25 is a block diagram illustrating another configuration of the tactile sense providing system according to the embodiments of the present technology.

FIG. 26 is a block diagram illustrating a hardware configuration of the control section included in the tactile sense providing system according to the embodiments of the present technology.

### MODE(S) FOR CARRYING OUT THE INVENTION

A tactile sense providing system according to embodiments of the present technology is described.

[Configuration of Tactile Sense Providing System]

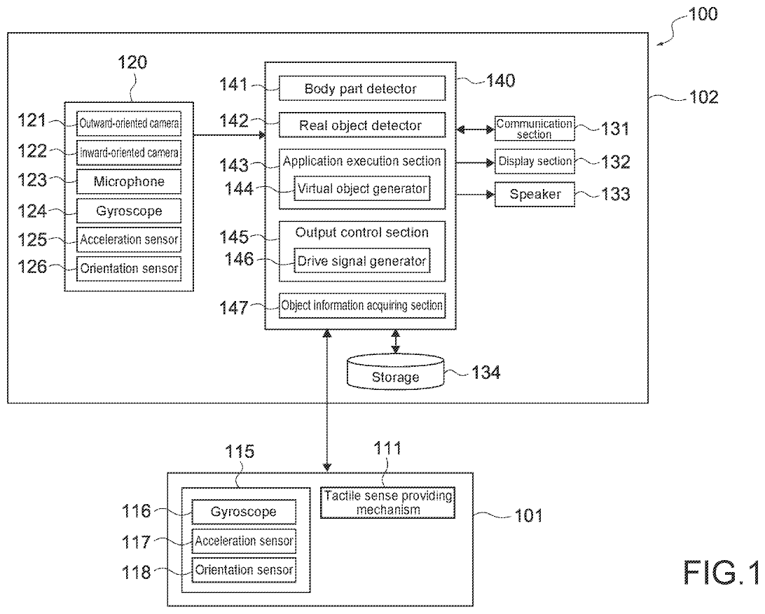

FIG. 1 is a block diagram illustrating a configuration of a tactile sense providing system 100 according to the present embodiment. As illustrated in the figure, the tactile sense providing system 100 includes a controller 101 and augmented reality (AR) glasses 102.

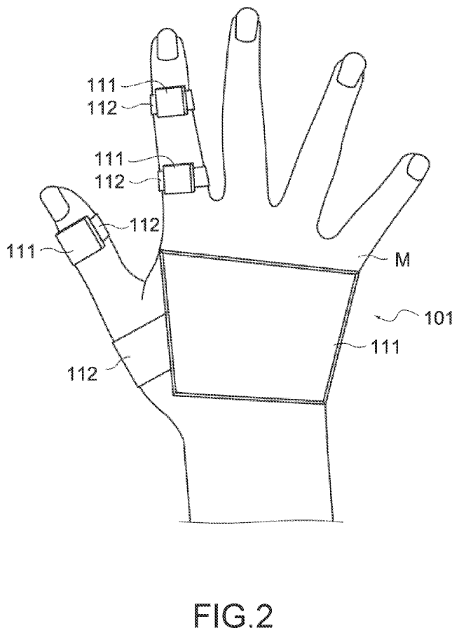

The controller 101 is worn on a body of a user to provide a tactile sense to the user. FIG. 2 schematically illustrates the controller 101. As illustrated in the figure, the controller 101 may be a hand controller that is worn on a hand M of the user.

As illustrated in FIG. 2, the controller 101 includes a tactile sense providing mechanism 111. The tactile sense providing mechanism 111 is brought into contact with the hand M to provide a tactile sense to the hand M. The tactile sense providing mechanism 111 may be an oscillation generation mechanism such as an eccentric motor or a piezoelectric actuator that can generate oscillation. Further, in addition to oscillation, the tactile sense providing mechanism 111 may also provide a change in temperature, or friction.

The tactile sense providing mechanism 111 is fixed to a specified portion of the hand M using a wearing tool 112. The wearing tool 112 is, for example, a belt-shaped wearing tool that is elastic or has a certain length that enables fastening. As illustrated in FIG. 2, the tactile sense providing mechanism 111 may be worn on any portion of the hand M, such as a back of a hand or a finger pad. The tactile sense providing mechanism 111 may be worn on all of or only some of the fingers. The number of tactile sense providing mechanisms 111 is not particularly limited, and a single tactile sense providing mechanism 111 or a plurality of tactile sense providing mechanisms 111 may be provided.

Further, as illustrated in FIG. 1, the controller 101 includes a sensor section 115. The sensor section 115 includes a gyroscope 116, an acceleration sensor 117, and an orientation sensor 118, and can detect a position and a pose of a part on which the sensor section 115 is worn.

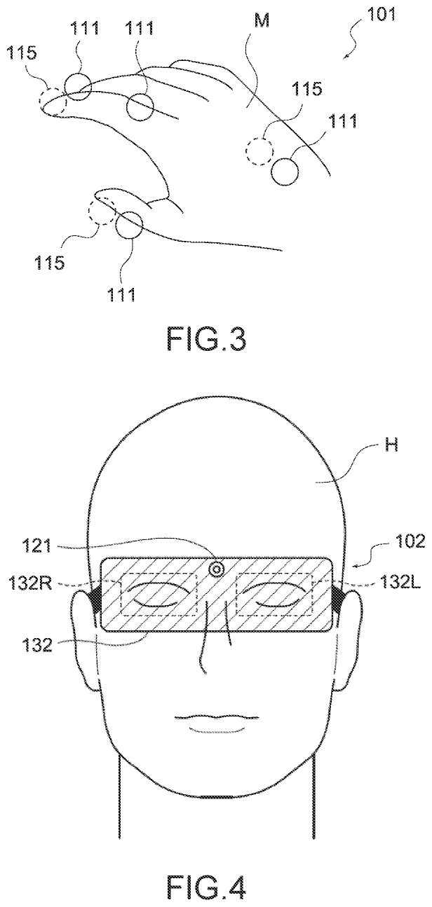

FIG. 3 schematically illustrates an example of an arrangement of the sensor section 115 and the tactile sense providing mechanism 111. As illustrated in the figure, the sensor sections 115 are arranged in portions respectively situated near some of the tactile sense providing mechanisms 111. Further, the sensor sections 115 may be arranged in portions respectively situated near all of the tactile sense providing mechanisms 111. The sensor section 115 does not necessarily have to be attached to all of the fingers, and may be attached to some of the fingers. Further, it is sufficient if the sensor section 115 can detect a position and a pose of a part on which the sensor section 115 is worn, and a configuration of the sensor section 115 is not particularly limited.

The AR glasses 102 are worn on a head of a user to provide an AR video to the user. Further, the AR glasses 102 serve as an information processing apparatus that controls the controller 101. FIG. 4 schematically illustrates the AR glasses 102. As illustrated in FIGS. 1 and 4, the AR glasses 102 include a sensor section 120, a communication section 131, a display section 132, a speaker 133, a storage 134, and a control section 140.

The sensor section 120 performs detection variously, and outputs a result of the detection to the control section 140. Specifically, the sensor section 120 includes an outward-oriented camera 121, an inward-oriented camera 122, a microphone 123, a gyroscope 124, an acceleration sensor 125, and an orientation sensor 126.

As illustrated in FIG. 4, the outward-oriented camera 121 is provided to the AR glasses 102, and captures an image of a region in the field of view to generate a captured image. The outward-oriented camera 121 outputs the generated captured image to the control section 140. The captured image may be a moving image or a plurality of consecutively captured still images.

The gyroscope 124, the acceleration sensor 125, and the orientation sensor 126 detect a position and a pose of the AR glasses 102, and outputs a result of the detection to the control section 140. Note that the sensor section 120 is not limited to having the configuration described above, and it is sufficient if the sensor section 120 includes at least the outward-oriented camera 121 and can detect a position and a pose of the AR glasses 102.

The communication section 131 connects the AR glasses 102 and an external apparatus. Specifically, the communication section 131 connects the AR glasses 102 and the controller 101 directly or through a network. Further, the communication section 131 may be capable of connecting the AR glasses 102 and another information processing apparatus directly or through a network.

The display section 132 displays a video output by the control section 140. The display section 132 is a transmissive display, and a user can view both a virtual object and a real space that are displayed by the display section 132. As illustrated in FIG. 4, the display section 132 includes a right-eye display section 132R and a left-eye display section 132L, and can three-dimensionally display the virtual object.

The speaker 133 reproduces sound output by the control section 140. A configuration of the speaker 133 is not particularly limited, and the speaker 133 does not necessarily have to be provided. The storage 134 is, for example, a hard disk drive (HDD) or a solid state drive (SSD), and stores therein, for example, an application executed by the control section 140.

The control section 140 is a functional structural element implemented by hardware such as a central processing unit (CPU) and software working cooperatively, and controls the AR glasses 102 and the controller 101. Specifically, as illustrated in FIG. 1, the control section 140 includes a body part detector 141, a real object detector 142, an application execution section 143, an output control section 145, and an object information acquiring section 147.

The body part detector 141 detects a position and a pose of a “specific part” from among a body of a user. The specific part may be a part, from among the body of the user, that is provided with the tactile sense providing mechanism 111, and the specific part may be a hand when the tactile sense providing mechanism 111 is worn on the hand, as illustrated in FIG. 2. Note that the “position” of a specific part refers to positional coordinates of the specific part in a real space, and the “pose” of the specific part refers to an orientation of the specific part (for example, an orientation of an extension direction of a finger) in the real space.

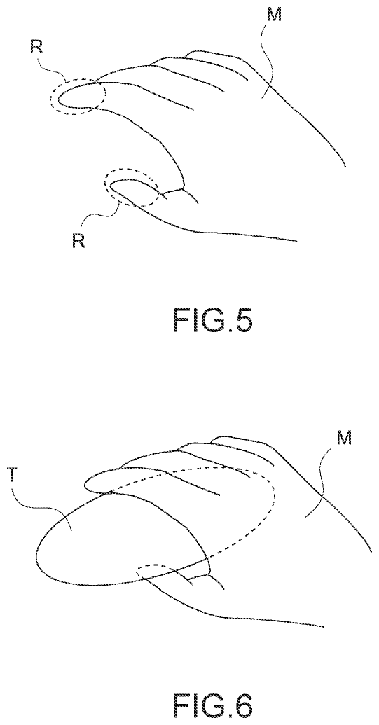

FIG. 5 schematically illustrates an example of a result of detection of a specific part that is performed by the body part detector 141. As illustrated in the figure, the body part detector 141 detects, as specific parts, tips (R in the figure) of an index finger and a thumb from among the hand M, and can detect positions and poses of the specific parts. Note that the specific part is not limited to the parts described above, and may be another finger, a palm of a hand, or another part of the body.

The body part detector 141 can acquire a captured image generated by the outward-oriented camera 121 (refer to FIG. 4), and can detect a position and a pose of a specific part by performing image processing on the captured image. Further, the body part detector 141 may detect the position and the pose of the specific part on the basis of output from the sensor section 115 (refer to FIG. 2), or may detect the position and the pose of the specific part on the basis of both the captured image and the output from the sensor section 115. For example, the body part detector 141 can also roughly detect the position and the pose of the specific part on the basis of the captured image, and detect the position and the pose of the specific part in detail using the output from the sensor section 115. The body part detector 141 supplies a result of the detection of the specific part to the application execution section 143 and the output control section 145.

Further, the body part detector 141 may detect a force of pressing performed by a specific part on a real object described later. The body part detector 141 may detect the pressing force on the basis of output from a pressure sensor worn on the specific part. The body part detector 141 may acquire, on the basis of a result of the detection of the real object, a weight of the real object with which the specific part is brought into contact, and may estimate the pressing force using the weight. When the body part detector 141 detects the force of pressing performed by the specific part on the real object, the body part detector 141 supplies the pressing force to the output control section 145.

The real object detector 142 detects a “real object”. The real object is not a virtual object, but an object that is actually situated in a real space. The type of real object is not particularly limited, and the real object is typically an object such as a toy, a tool, or a writing instrument that can be held by a user. FIG. 6 schematically illustrates an example of a real object that is detected by the real object detector 142. In the figure, the real object is a real object T held with the hand M of a user. The real object detector 142 can acquire a captured image captured by the outward-oriented camera 121, and can detect a real object by performing image processing on the captured image.

Further, when the real object detector 142 detects a real object, the real object detector 142 specifies a position of the real object and determines a type of the real object. The real object detector 142 can determine a type of the real object (such as a pen, a pair of scissors, or a toy sword) by image determination being performed on, for example, a shape and color of the detected real object using machine learning.

Note that, after a specific part is brought into contact with a real object, the real object may be hidden behind the specific part, or it may become difficult to see the entirety of the real object. Thus, the real object detector 142 may start determining a real object at a timing at which a specific part starts approaching the real object. Further, it is expected that object detection processing performed by the real object detector 142 will be delayed in real time. In this case, a nearby real object may be determined before a user causes a specific part to approach a real object, and a load imposed due to determination processing performed when the specific part is brought into contact with the real object may be reduced.

Further, instead of, or in addition to using image processing on a captured image, the real object detector 142 may detect and determine a real object using another method. For example, when a QR code (registered trademark) is being displayed on a real object, the real object detector 142 can determine the real object from a result of reading the QR code (registered trademark). Further, when an electronic tag is attached to a real object, the real object detector 142 can also determine the real object from a result of communicating with the electronic tag. Furthermore, the captured image is not limited to an image captured using the outward-oriented camera 121, and may be an image captured using a camera (such as a camera arranged on a wall surface) that is situated around a user.

The real object detector 142 supplies a result of the detection of the real object to the output control section 145 and the object information acquiring section 147. Note that the real object detector 142 may select a processing-target real object using a positional relationship with a specific part detected by the body part detector 141. The real object detector 142 can only specify a position of a processing-target real object and determine a type of the processing-target real object, and can deal with a non-processing-target real object as an object that does not exist. Specifically, the real object detector 142 may determine that a real object (for example, a real object held by a user) with which a specific part is in contact is a processing target, and may determine that a real object with which the specific part is out of contact is not a processing target.

Further, the real object detector 142 may determine that a certain real object (for example, a real object held by a user) with which a specific part is in contact, and another real object with which the certain real object is to be brought into contact are processing targets, and may determine that a real object other than the certain real object and the other real object is not a processing target. Furthermore, the real object detector 142 may determine that a certain real object that is to be touched by a user using a virtual object generated by the AR glasses 102 is a processing target, and may determine that a real object other than the certain real object is not a processing target. Moreover, the real object detector 142 may determine that a certain real object that is situated within a certain distance from a specific part is a processing target, and may determine that a real object other than the certain real object is not a processing target. The real object detector 142 may determine, without selecting a processing target, that all of the detected real objects are processing targets, or may select a processing-target real object only when a large number of real objects has been detected.

The application execution section 143 executes applications for, for example, an augmented reality (AR) game and operation supporting AR. The application execution section 143 includes a virtual object generator 144. The virtual object generator 144 generates a “virtual object” according to the application executed by the application execution section 143, on the basis of output from the sensor section 120. The virtual object is an object that is displayed on the display section 132 (refer to FIG. 4) to be virtually viewed by a user in a real space. Examples of a type of virtual object include a weapon, a tool, and a writing instrument, and the type of virtual object is not particularly limited. The application execution section 143 supplies the output control section 145 with an instruction to output, for example, sound, a video, a tactile sense, and a virtual object that are generated by an application being executed, the virtual object being generated by the virtual object generator 144.

The output control section 145 controls output from the controller 101 and output from the AR glasses 102 according to an output instruction supplied by the application execution section 143. Specifically, the output control section 145 generates a video signal according to the output instruction, and supplies the video signal to the display section 132 to cause a video to be displayed on the display section 132. Further, the output control section 145 generates a sound signal according to the output instruction, and supplies the sound signal to the speaker 133 to cause sound to be generated from the speaker 133.

The output control section 145 includes a drive signal generator 146. The drive signal generator 146 generates a drive signal for the tactile sense providing mechanism 111 according to the output instruction, and supplies the drive signal to the tactile sense providing mechanism 111. In this case, the drive signal generator 146 generates the drive signal on the basis of a positional relationship between a real object detected by the real object detector 142 and a specific part detected by the body part detector 141.

The drive signal generator 146 can determine whether the real object T and a specific part R are in contact with each other, and can generate a drive signal according to a result of the determination. The drive-signal generation performed by the drive signal generator 146 will be described in detail later. Further, the drive signal generator 146 may generate a drive signal such that the tactile sense providing mechanism 111 causes a tactile sense to occur when the specific part R is moved with respect to the real object T in a state in which the specific part R is in contact with the real object T. Furthermore, the drive signal generator 146 may determine whether a first object (a real object or a virtual object) and a second object (a real object or a virtual object) are in contact with each other, the first object being an object of which a position relative to the specific part R is fixed, the second object being an object of which a position relative to the specific part R is not fixed. Then, the drive signal generator 146 may generate the drive signal according to a result of the determination.

The object information acquiring section 147 acquires “related information” related to a real object detected by the real object detector 142. The related information is information related to a real object regardless of an appearance of the real object, and is, for example, a balance of a prepaid card when the real object is the prepaid card. When the real object detector 142 determines a real object, the object information acquiring section 147 can inquire of, for example, a server about information related to the real object using, for example, information (such as an electronic tag) held in the real object, and can acquire the related information.

The tactile sense providing system 100 has the configuration described above. Note that the configuration of the tactile sense providing system 100 is not limited to the configuration described above. For example, the control section 140 may be included in another information processing apparatus connected to the AR glasses 102. Further, at least some of the structural elements of the control section 140 may be implemented in a network. Furthermore, the control section 140 is not limited to having all of the structural elements described above, and, for example, the virtual object generator 144 and the object information acquiring section 147 do not necessarily have to be provided.

Further, the example in which the controller 101 is worn on a hand of a user has been described above. Without being limited thereto, the controller 101 may be worn on, for example, an arm, a leg, a head, or a body of the user. Furthermore, the tactile sense providing system 100 may include at least two controllers 101, and the at least two controllers 101 may be worn on at least two respective portions of the body such as right and left hands of a user.

[Operation of Tactile Sense Providing System]

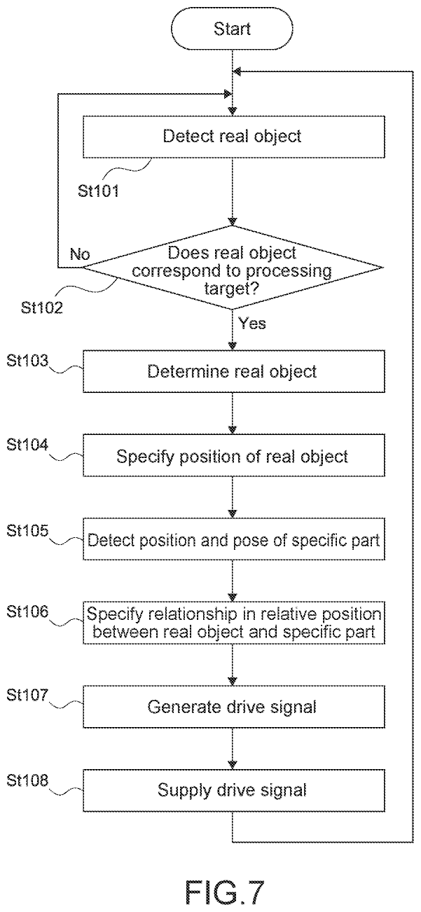

An operation of the tactile sense providing system 100 is described. FIG. 7 is a flowchart illustrating an operation of the tactile sense providing system 100.

As illustrated in the figure, first, the real object detector 142 detects a real object (St101). The real object detector 142 can detect a real object by, for example, performing image processing on a captured image. Next, the real object detector 142 performs selection with respect to the detected real object (St102). On the basis of a positional relationship with a specific part, the real object detector 142 can perform selection with respect to whether a real object is a processing target. For example, when a detected real object is in contact with a specific part, the real object detector 142 selects the detected real object as a processing target.

When the real object detector 142 has determined that a real object is not a processing target (St102; No), the detection of a real object (St101) is performed again. Further, when the real object detector 142 has determined that a real object is a processing target (St102; Yes), the real object is determined (St103). The real object detector 142 can determine a type of real object using, for example, a recognizer caused to perform machine learning.

Next, the real object detector 142 specifies a position of the real object (St104). The real object detector 142 can specify positional coordinates of a real object in a real space on the basis of, for example, a size and a shape of the real object in a captured image.

Next, the body part detector 141 detects a position and a pose of a specific part (St105). The body part detector 141 can detect the position and the pose of the specific part on the basis of a result of image processing performed on a captured image and output from the sensor section 115 (refer to FIG. 2). In this case, the body part detector 141 may also detect a force of pressing performed by a specific part on a real object.

Next, the drive signal generator 146 specifies a relationship in relative position between the real object and the specific part (St106). The drive signal generator 146 can compare a position of a real object that is detected by the real object detector 142 to a position and a pose of a specific part that are detected by the body part detector 141, and can specify the relationship in relative position between the real object and the specific part on the basis of a result of the comparison. Specifically, the drive signal generator 146 can specify whether a specific part is in contact with a real object.

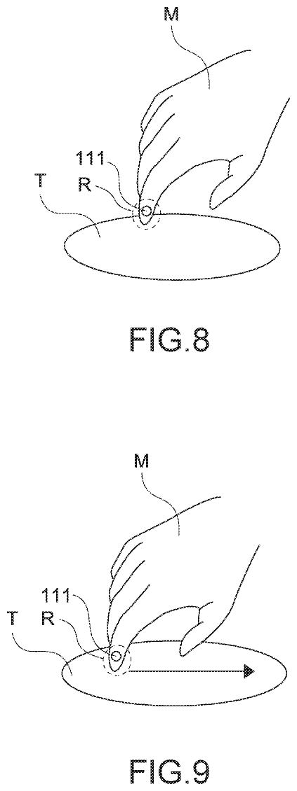

Next, the drive signal generator 146 generates a drive signal on the basis of a positional relationship between the real object and the specific part (St107). FIG. 8 is a schematic diagram illustrating a positional relationship between the specific part R and the real object T. As illustrated in the figure, the drive signal generator 146 can determine whether the specific part R and the real object T are in contact with each other, and can generate a drive signal such that the tactile sense providing mechanism 111 situated near the specific part R causes a tactile sense to occur when the specific part R is brought into contact with the real object T. In this case, the drive signal generator 146 may generate a drive signal according to a type of the real object T that is determined by the real object detector 142. For example, the drive signal generator 146 can provide, in advance, an oscillation waveform for each type of the real object T, and can change an amplitude and the number of oscillations according to the position and the pose of a specific part.

Further, the drive signal generator 146 may generate a drive signal according to a force of pressing performed by the specific part R on the real object T. For example, the drive signal generator 146 can generate a drive signal such that the tactile sense providing mechanism 111 causes a weaker tactile sense to occur if the pressing force is greater. A greater pressing force results in more easily providing a tactile sense to a specific part. Thus, the tactile sense perceived by a user can be kept at the same level regardless of pressing force. Further, as described later, the drive signal generator 146 may generate a drive signal according to a portion, in the real object T, with which the specific part R is in contact. The drive signal generator 146 may generate a drive signal according to related information (such as a balance of a prepaid card) related to the real object T detected by the real object detector 142.

Further, the positional relationship between the specific part R and the real object T may be gradually changed. FIG. 9 is a schematic diagram illustrating a change in a positional relationship between the specific part R and the real object T, where a movement of the specific part R is indicated by an arrow. As illustrated in the figure, the drive signal generator 146 may generate a drive signal such that the tactile sense providing mechanism 111 causes a tactile sense to occur when the specific part R is moved with respect to the real object T in a state in which the specific part R is in contact with the real object T.

In this case, the drive signal generator 146 may generate a drive signal according to one of a distance and a speed of movement of the specific part R with respect to the real object T, or according to both of them. For example, the drive signal generator 146 can generate a drive signal such that a tactile sense occurs every time the movement distance becomes a specified distance, or such that the tactile sense is provided at a shorter interval of time if the movement speed is higher.

Next, the drive signal generator 146 supplies the generated drive signal to the tactile sense providing mechanism 111 (St108). The tactile sense providing mechanism 111 causes a tactile sense to occur according to the drive signal. This enables the user to perceive a tactile sense depending on the positional relationship between a real object and a specific part.

The tactile sense providing system 100 is operated as described above. Note that the output control section 145 may generate, together with a drive signal, a signal for sound (such as frictional sound and collision sound) generated when a specific part is in contact with a real object, and may supply the sound signal to the speaker 133. This enables the user to perceive the sound together with a tactile sense provide by the tactile sense providing mechanism 111.

Further, the drive signal generator 146 may reflect information regarding a user in generation of a drive signal. When a change in the strength of a tactile sense is input through a user interface (UI) of the tactile sense providing system 100, the drive signal generator 146 can adjust a drive signal in response to the change being input. This makes it possible to respond when a user wants to feel a stronger tactile sense or when there is a reduction in sensitivity due to, for example, gloves being worn.

Furthermore, when the real object detector 142 detects a real object made of a processible material such as wood or paper, the real object detector 142 may determine a type of an object represented by the real object and consider the determined type as the type of the real object. For example, when the real object detector 142 detects a wooden toy sword, the real object detector 142 can consider the detected toy sword as a real sword and supply a result of the determination to the drive signal generator 146. The real object detector 142 can express a shape and design numerically when image determination is performed and determine the numerically expressed shape and designed as a result of the determination, in order to change, depending on the shape or the design, oscillation provided upon brandishing a sword. For example, the real object detector 142 may numerically express characteristics such as being thick, thin, long, and short from among the shape characteristics of a real object, or may perform numerical expression by treating, as a 24-bit value of RGB, an average color of colors in which a real object is painted.

With respect to the above-described operation of the tactile sense providing system 100, the example in which a drive signal is generated due to a specific part of a user being brought into contact with a real object has been described. However, it is sufficient if the drive signal generator 146 generates a drive signal on the basis of a positional relationship between a real object and a specific part. For example, the drive signal generator 146 may operate as described below.

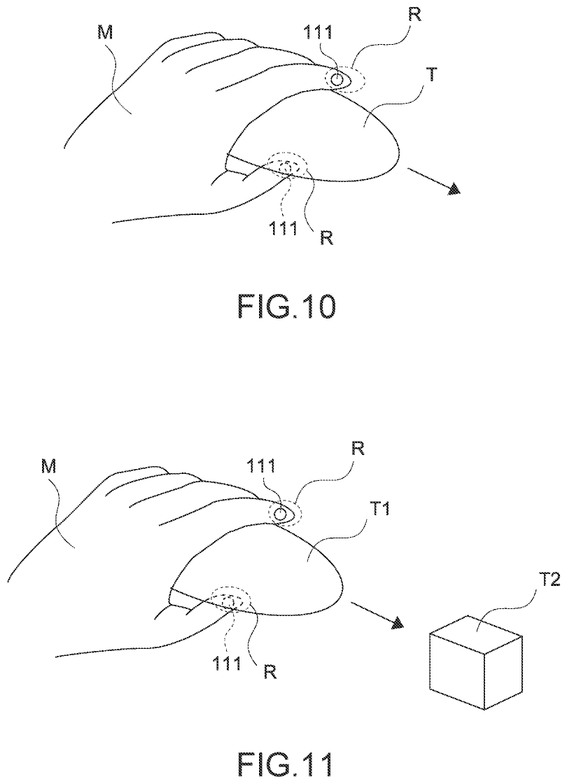

FIG. 10 is a schematic diagram illustrating another positional relationship between the specific part R and the real object T. As illustrated in the figure, a position of the real object T relative to the specific part R may be fixed, and the real object T may be moved along with the specific part R as indicated by an arrow. This is a state in which, for example, a user holds and moves the real object T with his/her hand. When the real object T and the specific part R are moved in a state of remaining in contact with each other, the drive signal generator 146 can generate a drive signal such that the tactile sense providing mechanism 111 causes a tactile sense to occur.

In this case, the drive signal generator 146 may generate a drive signal according to a type of the real object T that is determined by the real object detector 142. For example, the drive signal generator 146 can provide, in advance, an oscillation waveform for each type of the real object T, and can select an oscillation waveform according to the type of the real object T.

Further, the drive signal generator 146 may generate a drive signal according to one of a distance and a speed of movement of the specific part R, or according to both of them. For example, the drive signal generator 146 can generate a drive signal such that a tactile sense occurs every time the movement distance becomes a specified distance, or such that the tactile sense is provided at a shorter interval of time if the movement speed is higher. Furthermore, as described later, the drive signal generator 146 may generate a drive signal according to a portion, in the real object T, with which the specific part R is in contact. The drive signal generator 146 may generate a drive signal according to related information related to the real object T detected by the real object detector 142.

FIG. 11 is a schematic diagram illustrating another positional relationship between the specific part R and the real object T. As illustrated in the figure, the real objects include a first real object T1 and a second real object T2. The first real object T1 is a real object of which a position relative to the specific part R is fixed and that is moved along with the specific part R as indicated by an arrow. The second real object T2 is a real object of which a position relative to the specific part R is not fixed.

When the first real object T1 and the specific part R are moved in a state of remaining in contact with each other, the drive signal generator 146 can determine that a position of the first real object T1 relative to the specific part R is fixed. When the first real object T1 of which the position relative to the specific part R is fixed is brought into contact with the second real object T2, the drive signal generator 146 can generate a drive signal such that the tactile sense providing mechanism 111 causes a tactile sense to occur.

In this case, the drive signal generator 146 may generate a drive signal according to a set of a type of the first real object T1 and a type of the second real object T2 that are determined by the real object detector 142. For example, the drive signal generator 146 can provide, in advance, an oscillation waveform for each set of the type of the first real object T1 and the type of the second real object T2, and can select an oscillation waveform according to each set of the type of the first real object T1 and the type of the second real object T2.

Further, the drive signal generator 146 may generate a drive signal according to one of a distance and a speed of movement of a point of contact of the first real object T and the second real object T2, or according to both of them. For example, the drive signal generator 146 can generate a drive signal such that a tactile sense occurs every time the distance of movement of the point of contact becomes a specified distance, or such that the tactile sense is provided at a shorter interval of time if the speed of movement of the point of contact is higher. Furthermore, as described later, the drive signal generator 146 may generate a drive signal according to a portion, in the first real object T1, with which the specific part R is brought into contact. The drive signal generator 146 may generate a drive signal according to a point at which the first real object T1 and the second real object T2 are brought into contact with each other.

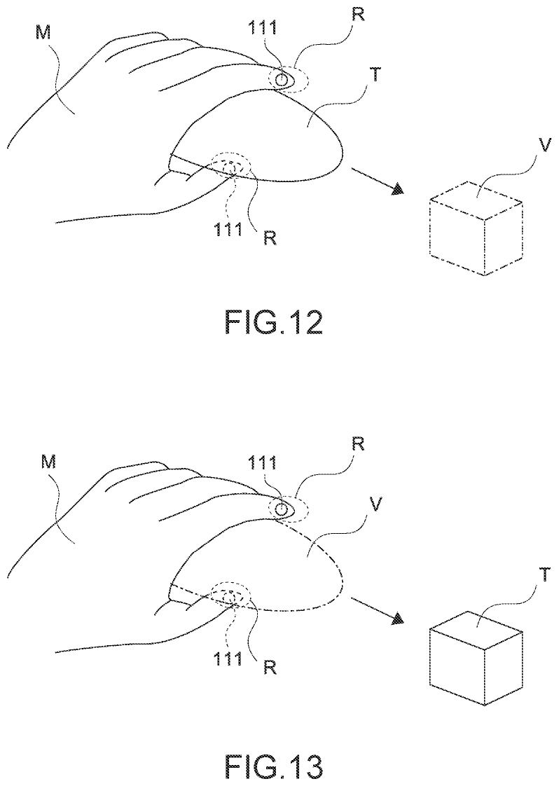

FIG. 12 is a schematic diagram illustrating another positional relationship between the specific part R and the real object T. As illustrated in the figure, a position of the real object T relative to the specific part R may be fixed, and the real object T may be moved along with the specific part R with respect to a virtual object V, as indicated by an arrow. The virtual object V is a virtual object of which a position relative to the specific part R is not fixed. The virtual object V is a virtual object generated by the virtual object generator 144 (refer to FIG. 1) and displayed on the display section 132. A user can view the real object T and the virtual object V together by viewing a real space through the display section 132.

When the real object T and the specific part R are moved in a state of remaining in contact with each other, the drive signal generator 146 can determine that a position of the real object T relative to the specific part R is fixed. When the real object T of which the position relative to the specific part R is fixed is brought into virtual contact with the virtual object V, the drive signal generator 146 can generate a drive signal such that the tactile sense providing mechanism 111 causes a tactile sense to occur.

In this case, the drive signal generator 146 may generate a drive signal according to a set of a type of the real object T that is determined by the real object detector 142, and a type of the virtual object V. For example, the drive signal generator 146 can provide, in advance, an oscillation waveform for each set of the type of the real object T and the type of the virtual object V, and can select an oscillation waveform according to each set of the type of the real object T and the type of the virtual object V.

Further, the drive signal generator 146 may generate a drive signal according to one of a distance and a speed of movement of a point of contact of the real object T and the virtual object V, or according to both of them. For example, the drive signal generator 146 can generate a drive signal such that a tactile sense occurs every time the distance of movement of the point of contact becomes a specified distance, or such that the tactile sense is provided at a shorter interval of time if the speed of movement of the point of contact is higher. Furthermore, as described later, the drive signal generator 146 may generate a drive signal according to a portion, in the real object T, with which the specific part R is brought into contact. The drive signal generator 146 may generate a drive signal according to a point at which the real object T and the virtual object V are brought into contact with each other.

FIG. 13 is a schematic diagram illustrating another positional relationship between the specific part R and the real object T. As illustrated in the figure, a position of the virtual object V relative to the specific part R may be fixed, and the virtual object V may be moved along with the specific part R with respect to the real object T, as indicated by an arrow. The real object T is a real object of which a position relative to the specific part R is not fixed. The virtual object V is a virtual object generated by the virtual object generator 144 (refer to FIG. 1) and displayed on the display section 132. A user can view the real object T and the virtual object V together by viewing a real space through the display section 132.

When the virtual object V of which the position relative to the specific part R is fixed is brought into virtual contact with the real object T, the drive signal generator 146 can generate a drive signal such that the tactile sense providing mechanism 111 causes a tactile sense to occur. In this case, the drive signal generator 146 may generate a drive signal according to a set of a type of the real object T that is determined by the real object detector 142, and a type of the virtual object V. For example, the drive signal generator 146 can provide, in advance, an oscillation waveform for each set of the type of the real object T and the type of the virtual object V, and can select an oscillation waveform according to each set of the type of the real object T and the type of the virtual object V.

Further, the drive signal generator 146 may generate a drive signal according to one of a distance and a speed of movement of a point of contact of the real object T and the virtual object V, or according to both of them. For example, the drive signal generator 146 can generate a drive signal such that a tactile sense occurs every time the distance of movement of the point of contact becomes a specified distance, or such that the tactile sense is provided at a shorter interval of time if the speed of movement of the point of contact is higher. Furthermore, as described later, the drive signal generator 146 may generate a drive signal according to a portion, in the virtual object V, with which the specific part R is brought into contact. The drive signal generator 146 may generate a drive signal according to a point at which the real object T and the virtual object V are brought into contact with each other.

The tactile sense providing system 100 operates as described above. In the tactile sense providing system 100, the drive signal generator 146 generates a drive signal for the tactile sense providing mechanism 111 worn on the specific part R, on the basis of a positional relationship between the specific part R and the real object T, as described above. This enables the tactile sense providing system 100 to cause a user to perceive a tactile sense that is different from a tactile sense directly obtained from the real object T, and thus to provide, to the user, the reality and the accuracy, or enjoyable different tactile senses.

### Examples of Specific Operation of Tactile Sense Providing System

Examples of a specific operation of the tactile sense providing system 100 are described. Note that it is assumed that, in Operation Examples described below, the specific part is each portion of the hand M and the tactile sense providing mechanism 111 is an oscillation generation mechanism.

### Operation Examples 1: Provision of Tactile Sense That is Performed by Specific Part Being Brought into Contact with Real Object

In Operation Examples 1, examples in which a tactile sense is provided due to a specific part being brought into contact with a real object are described. Operation Examples 1 include Operation Example 1-1, Operation Example 1-2, Operation Example 1-3, and Operation Example 1-4.

### Operation Example 1-1

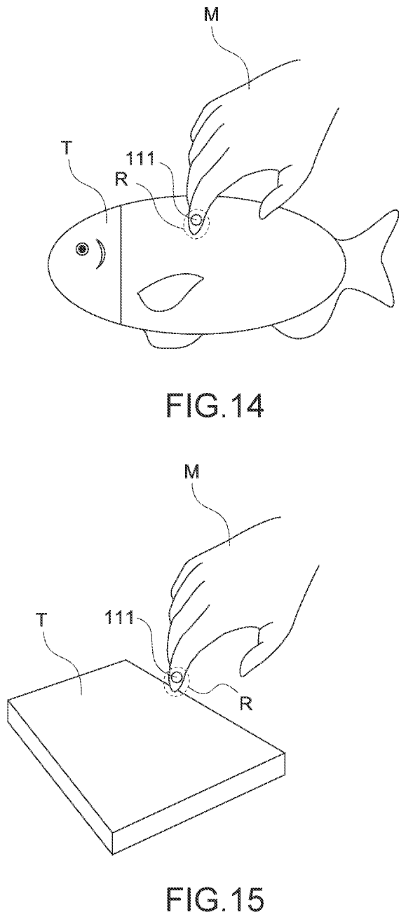

FIG. 14 schematically illustrates the specific part R and the real object T in Operation Example 1-1. The real object T is a wooden fish model. When the real object detector 142 determines that the real object T is a fish model, the real object detector 142 supplies the drive signal generator 146 with information regarding this matter and a position of the real object T. The real object detector 142 may perform determination using a recognizer caused to perform machine learning such that only a specific shape (a shape of a specific wooden fish) can be determined, or the real object may be determined by recognizing a label displayed on the real object. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. The drive signal generator 146 determines which portion in the real object T the specific part R is in contact with, and generates a drive signal according to the portion and the positional relationship described above. For example, when the surface of the real object T is stroked with the specific part R, the drive signal generator 146 generates a drive signal such that the tactile sense providing mechanism 111 generates oscillation. In this case, the drive signal generator 146 can cause the tactile sense providing mechanism 111 to generate oscillation of a specified frequency, and can cause a user to perceive a tactile sense to feel as if the user is in touch with scales of real fish.

This enables a user to perceive a tactile sense to feel as if the user is in touch with real fish, although the user is actually in touch with a wooden fish model. In this case, the drive signal generator 146 may change a frequency of oscillation generated by the tactile sense providing mechanism 111 according to one of a distance and a speed of movement of the specific part R in a state of being in contact with the real object T, or according to both of them. For example, the oscillation frequency can be made higher with a higher speed of movement of the specific part R.

### Operation Example 1-2

FIG. 15 schematically illustrates the specific part R and the real object T in Operation Example 1-2. It is assumed that the real object T is made of wood, and is a target object for processing such as cutting. When the real object detector 142 determines that the real object T is made of wood, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. The drive signal generator 146 can determine which portion in the real object T the specific part R is in contact with, and can generate a drive signal according to the portion and the positional relationship described above. For example, when the edge of the real object T is stroked with the specific part R, the drive signal generator 146 generates a drive signal such that the tactile sense providing mechanism 111 generates oscillation. In this case, the drive signal generator 146 can cause the tactile sense providing mechanism 111 to generate oscillation at a specified location on the wood, and can indicate a processed portion to a user.

Further, the drive signal generator 146 may move the tactile sense providing mechanism 111 according to one of a distance and a speed of movement of the specific part R in a state of being in contact with the real object T, or according to both of them. For example, the drive signal generator 146 can cause oscillation to be generated every time the distance of movement of the specific part R becomes a specified distance. This enables a user to grasp a processed portion using oscillation as graduation.

### Operation Example 1-3

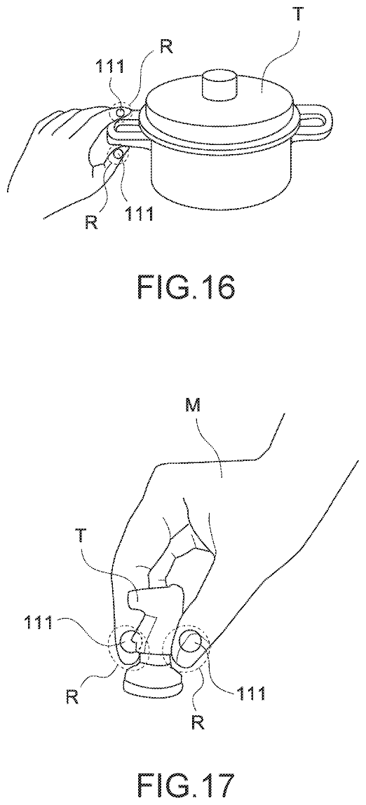

FIG. 16 schematically illustrates the specific part R and the real object T in Operation Example 1-3. The real object T is a toy pot. When the real object detector 142 determines that the real object T is a toy pot, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose of the specific part R to the drive signal generator 146.

The drive signal generator 146 generates a drive signal according to a positional relationship between the specific part R and the real object T. The drive signal generator 146 can determine whether the real object T is held with the specific part R, and can generate a drive signal according to a result of the determination. For example, when the real object T is held with the specific part R, the drive signal generator 146 can generate a drive signal such that the tactile sense providing mechanism 111 generates oscillation to cause a user to feel as if water is boiling.

### Operation Example 1-4

FIG. 17 schematically illustrates the specific part R and the real object T in Operation Example 1-4. The real object T is a chesspiece. When the real object detector 142 determines that the real object T is a chesspiece, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. The drive signal generator 146 can determine whether the real object T is held with the specific part R, and can generate a drive signal according to a result of the determination. For example, when the real object T is held with the specific part R, the drive signal generator 146 can generate a drive signal such that the tactile sense providing mechanism 111 generates, according to the type of chesspiece, oscillation to cause a user to feel as if the chesspiece is acting up (such as oscillation to swing from side to side with a low frequency).

### Operation Examples 2: Provision of Tactile Sense that is Performed when Real Object is Moved Along with Specific Part

In Operation Examples 2, examples in which a real object is moved along with a specific part are described. Operation Examples 2 include Operation Example 2-1, Operation Example 2-2, and Operation Example 2-3.

### Operation Example 2-1

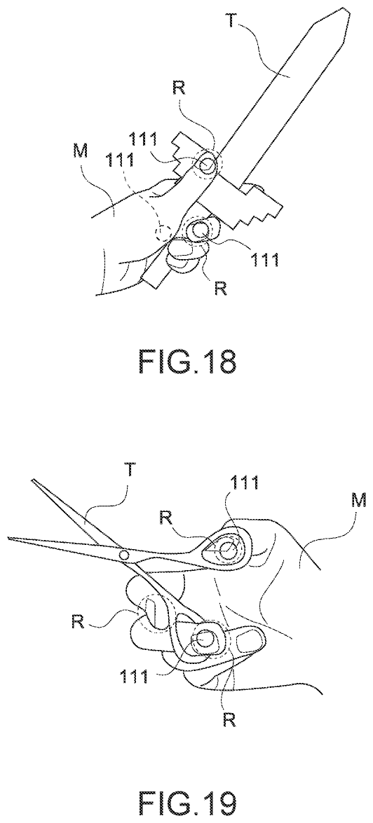

FIG. 18 schematically illustrates the specific part R and the real object T in Operation Example 2-1. The real object T is a toy sword. When the real object detector 142 determines that the real object T is a toy sword, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. When the real object T and the specific part R are moved in a state of remaining in contact with each other, the drive signal generator 146 can determine that the real object T is held with the specific part R. For example, the drive signal generator 146 generates a drive signal such that the tactile sense providing mechanism 111 generates, according to a speed of movement of the real object T, oscillation to cause a user to feel like swishing.

Further, the drive signal generator 146 can also determine which portion in the real object T the specific part R is in contact with, and can generate a drive signal according to the portion and the positional relationship described above. The drive signal generator 146 can determine whether a portion, in the toy sword, that is situated close to a sword guard is held with the specific part R, or a portion, in the toy sword, that is situated away from the sword guard is held with the specific part R, and can generate a drive signal according to a result of the determination. For example, the drive signal generator 146 can make an amplitude greater when the portion situated away from the sword guard is held with the specific part R, compared to when the portion situated close to the sword guard is held with the specific part R. In general, when a user is holding the portion situated away from the sword guard, the use feels a stronger force upon swinging the sword. Thus, when the drive signal generator 146 generates a drive signal according to a distance between the held portion and the sword guard, this results in causing the user to feel as if the user is brandishing a real sword although the user is actually brandishing a toy sword.

Note that, in addition to a drive signal, the output control section 145 may generate a video signal that includes visual effects for, for example, a sword, and may supply the video signal to the display section 132. This enables a user to view the visual effects virtually superimposed on the toy sword.

### Operation Example 2-2

FIG. 19 schematically illustrates the specific part R and the real object T in Operation Example 2-2. The real object T is a pair of scissors. When the real object detector 142 determines that the real object T is a pair of scissors, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. When the real object T and the specific part R are moved in a state of remaining in contact with each other, the drive signal generator 146 can determine that the real object T is held with the specific part R. For example, the drive signal generator 146 can generate a drive signal such that the tactile sense providing mechanism 111 generates, according to a speed of movement of the real object T, oscillation that provides a sense of clicking. This enables a user to grasp, due to oscillation, a cut length when the user cuts, for example, cloth using a pair of scissors.

### Operation Example 2-3

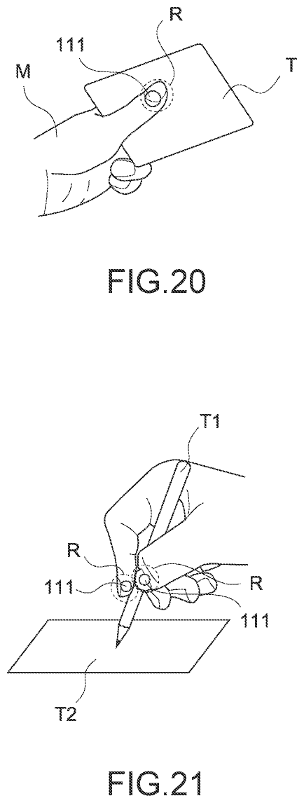

FIG. 20 schematically illustrates the specific part R and the real object T in Operation Example 2-3. The real object T is a prepaid card. When the real object detector 142 determines that the real object T is a prepaid card, the real object detector 142 supplies the drive signal generator 146 with information regarding this matter and a position of the real object T. Further, the real object detector 142 supplies the object information acquiring section 147 with information indicating that the detected object is a prepaid card. The object information acquiring section 147 acquires a balance of the prepaid card as related information by reading the balance of the prepaid card directly from the real object T, or through a server, and supplies the related information to the drive signal generator 146. The body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R and the real object T. When the real object T and the specific part R are moved in a state of remaining in contact with each other, the drive signal generator 146 can determine that the real object T is held with the specific part R, and the drive signal generator 146 can generate a drive signal such that the tactile sense providing mechanism 111 generates oscillation when the real object T is being held.

Further, the drive signal generator 146 can generate a drive signal according to the related information supplied by the object information acquiring section 147. For example, the drive signal generator 146 can generate a drive signal such that the tactile sense providing mechanism 111 generates oscillation to cause a user to feel as if a savings box that contains coins equivalent to the balance of the prepaid card is waved. Furthermore, the drive signal generator 146 may generate a drive signal such that short oscillation is generated only once when the prepaid card has a low balance, and short oscillation is generated multiple times when the prepaid card has a high balance. This enables a user to grasp a balance of a prepaid card by just waving the prepaid card.

### Operation Examples 3: Provision of Tactile Sense that is Performed in Response to Object Moved with Specific Part being Brought into Contact with Another Object

In Operation Examples 3, examples in which a tactile sense is provided in response to an object moved with a specific part being brought into contact with another object are described. Operation Examples 3 include Operation Example 3-1, Operation Example 3-2, Operation Example 3-3, and Operation Example 3-4.

### Operation Example 3-1

FIG. 21 schematically illustrates the specific part R, the first real object T1, and the second real object T2 in Operation Example 3-1. The first real object T1 is a writing instrument and the second real object T2 is paper. When the real object detector 142 determines that the first real object T1 is a writing instrument and the second real object T2 is paper, the real object detector 142 supplies the drive signal generator 146 with information regarding this matter and positions of the first real object T1 and the second real object T2. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R, the first real object T1, and the second real object T2. When the specific part R and the first real object T1 are moved in a state of remaining in contact with each other, the drive signal generator 146 can determine that the first real object T1 is held with the specific part R. Further, the drive signal generator 146 can determine whether the first real object T1 and the second real object T2 are in contact with each other, on the basis of a positional relationship between the first real object T1 and the second real object T2, and can determine a point of contact of the first real object T1 and the second real object T2 (for example, whether a tip of the writing instrument is in contact with the paper).

Further, on the basis of a position and a pose of the specific part R, and on the basis of a positional relationship of the specific part R with the first real object T1, the drive signal generator 146 determines a portion, in the first real object T1, with which the specific part R is in contact. The drive signal generator 146 can generate a drive signal on the basis of the type of first real object T1, the type of second real object T2, a point of contact of the first real object T1 and the second real object T2, and a distance or a speed of movement of the point of contact of the first real object T1 and the second real object T2.

For example, the drive signal generator 146 generates a drive signal such that the tactile sense providing mechanism 111 generates oscillation every time the distance of movement of the first real object T1 with respect to the second real object T2 becomes a specified distance. This enables a user to grasp the distance of movement of the first real object T1. Further, the drive signal generator 146 makes an oscillation frequency higher if the first real object T1 moves at a higher speed. Accordingly, the drive signal generator 146 can provide a tactile sense that causes a user to feel as if friction is caused.

### Operation Example 3-2

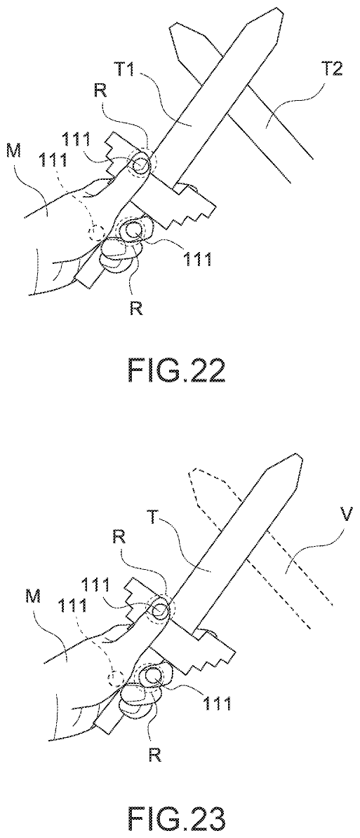

FIG. 22 schematically illustrates the specific part R, the first real object T1, and the second real object T2 in Operation Example 3-2. The first real object T1 is a toy sword held by a user of the tactile sense providing system 100, and the second real object T2 is a toy sword held by a person other than the user. When the real object detector 142 determines that the first real object T1 and the second real object T2 are toy swords, the real object detector 142 supplies the drive signal generator 146 with information regarding this matter and positions of the first real object T1 and the second real object T2. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R, the first real object T1, and the second real object T2. When the specific part R and the first real object T1 are moved in a state of remaining in contact with each other, the drive signal generator 146 can determine that the first real object T1 is held with the specific part R. Further, the drive signal generator 146 can determine whether the first real object T1 and the second real object T2 are in contact with each other, on the basis of a positional relationship between the first real object T1 and the second real object T2, and can determine a point of contact of the first real object T1 and the second real object T2.

Further, on the basis of a position and a pose of the specific part R, and on the basis of a positional relationship of the specific part R with the first real object T1, the drive signal generator 146 determines a portion, in the first real object T1, with which the specific part R is in contact. The drive signal generator 146 can generate a drive signal on the basis of the type of first real object T1, the type of second real object T2, a point of contact of the first real object T1 and the second real object T2, and a distance or a speed of movement of the point of contact of the first real object T1 and the second real object T2.

For example, even if the first real object T1 and the second real object T2 are made of plastic, the drive signal generator 146 causes oscillation to be generated when the first real object T1 and the second real object T2 clash. This enables a user to perceive a tactile sense to feel as if metallic swords are clashing. Further, the drive signal generator 146 can cause oscillation to be generated when a point of contact of the first real object T1 and the second real object T2 is moved. This enables a user to perceive a tactile sense to feel as if metallic swords are being rubbed with each other.

### Operation Example 3-3

FIG. 23 schematically illustrates the specific part R, the real object T, and the virtual object V in Operation Example 3-3. The real object T is a toy sword held by a user of the tactile sense providing system 100, and the virtual object V is a virtual object that is generated by the virtual object generator 144 (refer to FIG. 1) and displayed on the display section 132. The user can view the real object T and the virtual object V together by viewing a real space through the display section 132. For example, the virtual object V is held by a character of a game executed by the application execution section 143, or is a virtual object based on a toy sword held by a player who is other than the user and situated in a distant place.

When the real object detector 142 determines that the real object T is a toy sword, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R, the real object T, and the virtual object V. When the specific part R and the real object T are moved in a state of remaining in contact with each other, the drive signal generator 146 can determine that the real object T is held with the specific part R. Further, the drive signal generator 146 acquires a position of the virtual object V from the virtual object generator 144. The drive signal generator 146 can determine whether the real object T and the virtual object V are in contact with each other, on the basis of a positional relationship between the real object T and the virtual object V, and can determine a point of contact of the real object T and the virtual object V on the basis of the positional relationship between the real object T and the virtual object V.

The drive signal generator 146 can generate a drive signal on the basis of the type of real object T, the type of virtual object V, a point of contact of the real object T and the virtual object V, and a distance or a speed of movement of the point of contact. For example, the drive signal generator 146 causes the tactile sense providing mechanism 111 to generate oscillation when the real object T virtually clashes with the virtual object V. This enables a user to perceive a tactile sense to feel as if the real object T and a real object are clashing. Further, the drive signal generator 146 can cause oscillation to be generated when a point of contact of the real object T and the virtual object V is moved. This enables a user to perceive a tactile sense to feel as if real objects are being rubbed with each other.

### Operation Example 3-4

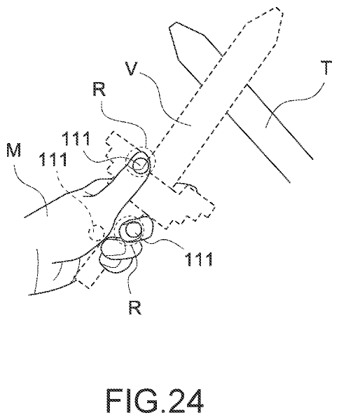

FIG. 24 schematically illustrates the specific part R, the real object T, and the virtual object V in Operation Example 3-4. The real object T is a toy sword, and the virtual object V is a virtual object that is generated by the virtual object generator 144 (refer to FIG. 1) and displayed on the display section 132. A user can view the real object T and the virtual object V together by viewing a real space through the display section 132. The virtual object V is arranged by the virtual object generator 144 as if the virtual object V is fixed relatively to the specific part R, and the user can recognize as if the user is holding the virtual object V. The real object T may be held by a player who is other than the user and situated near the user.

When the real object detector 142 determines that the real object T is a toy sword, the real object detector 142 supplies the drive signal generator 146 with information regarding this matter and a position of the real object T. Further, the body part detector 141 detects a position and a pose of the specific part R on the basis of output from, for example, the sensor section 115, and supplies the detected position and pose to the drive signal generator 146.

The drive signal generator 146 generates a drive signal according to a positional relationship between the specific part R, the real object T, and the virtual object V. The drive signal generator 146 acquires a position of the virtual object V from the virtual object generator 144. The drive signal generator 146 can determine whether the real object T and the virtual object V are in contact with each other, on the basis of a positional relationship between the real object T and the virtual object V, and can determine a point of contact of the real object T and the virtual object V on the basis of the positional relationship between the real object T and the virtual object V.

The drive signal generator 146 can generate a drive signal on the basis of the type of real object T, the type of virtual object V, a point of contact of the real object T and the virtual object V, and a distance or a speed of movement of the point of contact. For example, the drive signal generator 146 causes the tactile sense providing mechanism 111 to generate oscillation when the virtual object V virtually clashes with the real object T. This enables a user to perceive a tactile sense to feel as if the user is holding a real object. Further, the drive signal generator 146 can cause oscillation to be generated when a point of contact of the real object T and the virtual object V is moved. This enables a user to perceive a tactile sense to feel as if real objects are being rubbed with each other.

Moreover, the real object T may be a cutting-target object such as vegetable, fruit, or a wooden object. When a user moves the virtual object V such as a virtual sword, a virtual kitchen knife, or a virtual saw to perform a motion of cutting the cutting-target object, the drive signal generator 146 can cause oscillation to occur, the oscillation causing a user to feel as if the cutting-target object is being cut, although the cutting-target object is not actually cut. In this case, a drive signal may be generated such that the occurring oscillation differs depending on the type of cutting-target object.

The tactile sense providing system 100 may be capable of performing all of, or only some of Operation Examples described above.

[Another Configuration of Tactile Sense Providing System]

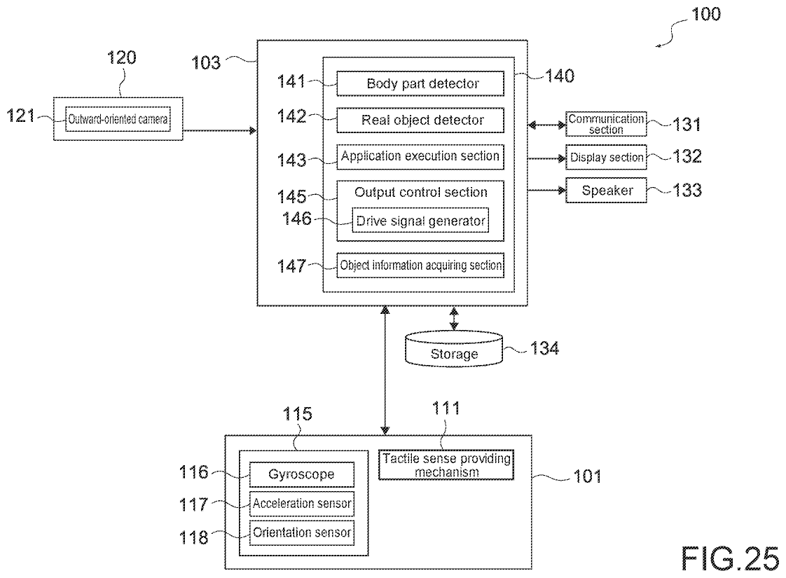

The example in which the tactile sense providing system 100 includes the AR glasses 102 has been described above. However, the tactile sense providing system 100 does not necessarily have to include the AR glasses 102. FIG. 25 is a block diagram of the tactile sense providing system 100 having another configuration.

As illustrated in the figure, the tactile sense providing system 100 may include an information processing apparatus 103 instead of the AR glasses 102. The information processing apparatus 103 includes the control section 140 described above, and can control the controller 101. The information processing apparatus 103 does not include a function of displaying a virtual object using the AR glasses. Except for this point, the information processing apparatus 103 can operate similarly to the AR glasses 102.

Further, the information processing apparatus 103 may display a virtual object by controlling AR glasses connected to the information processing apparatus 103. As illustrated in the figure, the sensor section 120 may only include the outward-oriented camera 121, and, in addition to the outward-oriented camera 121, the sensor section 120 may include a sensor that can detect a real object.

[Hardware Configuration of Information Processing Apparatus]

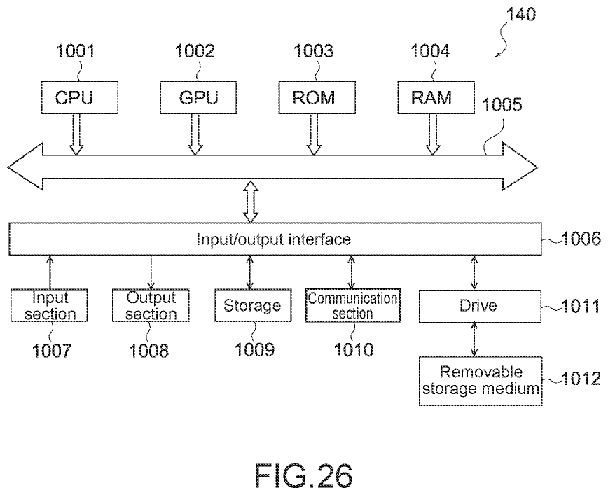

A hardware configuration that makes it possible to implement a functional configuration of the control section 140 included in the AR glasses 102 and the information processing apparatus 103 is described. FIG. 26 schematically illustrates a hardware configuration of the control section 140.

As illustrated in the figure, the control section 140 includes a central processing unit (CPU) 1001 and a graphics processing unit (GPU) 1002. An input/output interface 1006 is connected to the CPU 1001 and the GPU 1002 via a bus 1005. A read only memory (ROM) 1003 and a random access memory (RAM) 1004 are connected to the bus 1005.

An input section 1007, an output section 1008, a storage 1009, and a communication section 1010 are connected to the input/output interface 1006. The input section 1007 includes input devices such as a keyboard and a mouse that are used by a user to input an operation command. The output section 1008 outputs a processing operation screen and an image of a processing result to a display device. The storage 1009 includes, for example, a hard disk drive that stores therein a program and various data. The communication section 1010 includes, for example, a local area network (LAN) adapter, and performs communication processing through a network as represented by the Internet. Further, a drive 1011 is connected to the input/output interface 1006. The drive 1011 reads data from and writes data into a removable storage medium 1012 such as a magnetic disk, an optical disk, a magneto-optical disk, or a semiconductor memory.

The CPU 1001 performs various processes in accordance with a program stored in the ROM 1003, or in accordance with a program that is read from the removable storage medium 1012 such as a magnetic disk, an optical disk, a magneto-optical disk, or a semiconductor memory to be installed on the storage 1009, and is loaded into the RAM 1004 from the storage 1009. Data necessary for the CPU 1001 to perform various processes is also stored in the RAM 1004 as necessary. The GPU 1002 performs calculation processing necessary to draw an image under the control of the CPU 1001.

In the control section 140 having the configuration described above, the series of processes described above is performed by the CPU 1001 loading, for example, a program stored in the storage 1009 into the RAM 1004 and executing the program via the input/output interface 1006 and the bus 1005.

For example, the program executed by the control section 140 can be provided by being recorded in the removable storage medium 1012 serving as, for example, a package medium. Further, the program can be provided via a wired or wireless transmission medium such as a local area network, the Internet, or digital satellite broadcasting.

In the control section 140, the program can be installed on the storage 1009 via the input/output interface 1006 by the removable storage medium 1012 being mounted on the drive 1011. Further, the program can be received by the communication section 1010 via the wired or wireless transmission medium to be installed on the storage 1009. Moreover, the program can be installed in advance on the ROM 1003 or the storage 1009.

Note that the program executed by the control section 140 may be a program in which processes are chronologically performed in the order of the description in the present disclosure, or may be a program in which processes are performed in parallel or a process is performed at a necessary timing such as a timing of calling.

All of the hardware configuration of the control section 140 does not have to be included in a single apparatus, and the control section 140 may include a plurality of apparatuses. Further, a portion of or all of the hardware configuration of the control section 140 may be included in a plurality of apparatuses connected to each other via a network.

Note that the present technology may also take the following configurations.

(1) An information processing apparatus, including:
a real object detector that detects a real object;
a body part detector that detects a position and a pose of a part of a body; and
a drive signal generator that generates a drive signal on the basis of a positional relationship between the real object and the part, the drive signal being supplied to a tactile sense providing mechanism that is worn on the part.
   (2) The information processing apparatus according to (1), in which
the real object detector determines a type of the real object, and
the drive signal generator generates the drive signal further according to the type.
   (3) The information processing apparatus according to (1) or (2), in which
the drive signal generator determines whether the real object and the part are in contact with each other, on the basis of the positional relationship between the real object and the part, and generates the drive signal according to a result of the determination.
   (4) The information processing apparatus according to (3), in which
when the part is brought into contact with the real object, the drive signal generator generates the drive signal such that the tactile sense providing mechanism causes a tactile sense to occur.
   (5) The information processing apparatus according to (4), in which
the drive signal generator generates the drive signal according to a force of pressing performed by the part on the real object.
   (6) The information processing apparatus according to (3), in which
when the part is moved with respect to the real object in a state in which the part is in contact with the real object, the drive signal generator generates the drive signal such that the tactile sense providing mechanism causes a tactile sense to occur.
   (7) The information processing apparatus according to (6), in which
the drive signal generator generates the drive signal according to at least one of a distance or a speed of movement of the part with respect to the real object.
   (8) The information processing apparatus according to (3), in which
when the real object and the part are moved in a state of remaining in contact with each other, the drive signal generator generates the drive signal such that the tactile sense providing mechanism causes a tactile sense to occur.
   (9) The information processing apparatus according to (8), in which
the drive signal generator generates the drive signal according to at least one of a distance or a speed of movement of the real object.
   (10) The information processing apparatus according to (8) or (9), in which
the drive signal generator generates the drive signal according to a portion, in the real object, with which the specific part is in contact.
   (11) The information processing apparatus according to (1), in which
the drive signal generator determines whether a first object and a second object are in contact with each other, the first object being an object of which a position relative to the part is fixed, the second object being an object of which a position relative to the part is not fixed,
the drive signal generator generates the drive signal according to a result of the determination, and
at least one of the first object or the second object is the real object.
   (12) The information processing apparatus according to (11), in which
the first object and the second object are the real objects.
   (13) The information processing apparatus according to (11), further including
a virtual object generator that generates a virtual object in a real space, in which
the first object is the real object, and
the second object is the virtual object.
   (14) The information processing apparatus according to (11), further including
a virtual object generator that generates a virtual object in a real space, in which
the first object is the virtual object, and
the second object is the real object.
   (15) The information processing apparatus according to any one of (11) to (14), in which
the drive signal generator generates the drive signal according to at least one of a distance or a speed of movement of a point of contact of the first object and the second object.
   (16) The information processing apparatus according to any one of (1) to (15), in which
the part is a hand, and
the body part detector detects a position and a pose of the hand on the basis of output from a sensor that is worn on the hand.
   (17) The information processing apparatus according to any one of (1) to (16), further including
an object information acquiring section that acquires information related to the real object, in which
the drive signal generator generates the drive signal further according to the information.
   (18) The information processing apparatus according to any one of (1) to (17), in which
the tactile sense providing mechanism is an oscillation generation mechanism that is capable of generating oscillation, and
the drive signal generator generates, as the drive signal, a waveform of the oscillation generated by the oscillation generation mechanism.
   (19) A tactile sense providing system, including:
a tactile sense providing mechanism that is worn on a part of a body; and
an information processing apparatus that includes
   a real object detector that detects a real object,
   a body part detector that detects a position and a pose of the part, and
   a drive signal generator that generates a drive signal on the basis of a positional relationship between the real object and the part, the drive signal being supplied to the tactile sense providing mechanism.
      (20) A program that causes an information processing apparatus to operate as
a real object detector that detects a real object,
a body part detector that detects a position and a pose of a part of a body, and
a drive signal generator that generates a drive signal on the basis of a positional relationship between the real object and the part, the drive signal being supplied to a tactile sense providing mechanism that is worn on the part.

### REFERENCE SIGNS LIST

100 tactile sense providing system
101 controller
102 AR glasses
103 information processing apparatus
110 controller
111 tactile sense providing mechanism
140 control section
141 body part detector
142 real object detector
143 application execution section
144 virtual object generator
145 output control section
146 drive signal generator
147 object information acquiring section

1. An information processing apparatus, comprising:
a real object detector that detects a real object;
a body part detector that detects a position and a pose of a part of a body; and
a drive signal generator that generates a drive signal on a basis of a positional relationship between the real object and the part, the drive signal being supplied to a tactile sense providing mechanism that is worn on the part.

2. The information processing apparatus according to claim 1, wherein
the real object detector determines a type of the real object, and
the drive signal generator generates the drive signal further according to the type.

3. The information processing apparatus according to claim 2, wherein
the drive signal generator determines whether the real object and the part are in contact with each other, on the basis of the positional relationship between the real object and the part, and generates the drive signal according to a result of the determination.

4. The information processing apparatus according to claim 3, wherein
when the part is brought into contact with the real object, the drive signal generator generates the drive signal such that the tactile sense providing mechanism causes a tactile sense to occur.

5. The information processing apparatus according to claim 4, wherein
the drive signal generator generates the drive signal according to a force of pressing performed by the part on the real object.

6. The information processing apparatus according to claim 3, wherein
when the part is moved with respect to the real object in a state in which the part is in contact with the real object, the drive signal generator generates the drive signal such that the tactile sense providing mechanism causes a tactile sense to occur.

7. The information processing apparatus according to claim 6, wherein
the drive signal generator generates the drive signal according to at least one of a distance or a speed of movement of the part with respect to the real object.

8. The information processing apparatus according to claim 3, wherein
when the real object and the part are moved in a state of remaining in contact with each other, the drive signal generator generates the drive signal such that the tactile sense providing mechanism causes a tactile sense to occur.

9. The information processing apparatus according to claim 8, wherein
the drive signal generator generates the drive signal according to at least one of a distance or a speed of movement of the real object.

10. The information processing apparatus according to claim 8, wherein
the drive signal generator generates the drive signal according to a portion, in the real object, with which the specific part is in contact.

11. The information processing apparatus according to claim 1, wherein
the drive signal generator determines whether a first object and a second object are in contact with each other, the first object being an object of which a position relative to the part is fixed, the second object being an object of which a position relative to the part is not fixed,
the drive signal generator generates the drive signal according to a result of the determination, and
at least one of the first object or the second object is the real object.

12. The information processing apparatus according to claim 11, wherein
the first object and the second object are the real objects.

13. The information processing apparatus according to claim 11, further comprising
a virtual object generator that generates a virtual object in a real space, wherein
the first object is the real object, and
the second object is the virtual object.

14. The information processing apparatus according to claim 11, further comprising
a virtual object generator that generates a virtual object in a real space, wherein
the first object is the virtual object, and
the second object is the real object.

15. The information processing apparatus according to claim 11, wherein
the drive signal generator generates the drive signal according to at least one of a distance or a speed of movement of a point of contact of the first object and the second object.

16. The information processing apparatus according to claim 1, wherein
the part is a hand, and
the body part detector detects a position and a pose of the hand on a basis of output from a sensor that is worn on the hand.

17. The information processing apparatus according to claim 1, further comprising
an object information acquiring section that acquires information related to the real object, wherein
the drive signal generator generates the drive signal further according to the information.

18. The information processing apparatus according to claim 1, wherein
the tactile sense providing mechanism is an oscillation generation mechanism that is capable of generating oscillation, and
the drive signal generator generates, as the drive signal, a waveform of the oscillation generated by the oscillation generation mechanism.

19. A tactile sense providing system, comprising:
a tactile sense providing mechanism that is worn on a part of a body; and
an information processing apparatus that includes
a real object detector that detects a real object,
a body part detector that detects a position and a pose of the part, and
a drive signal generator that generates a drive signal on a basis of a positional relationship between the real object and the part, the drive signal being supplied to the tactile sense providing mechanism.

20. A program that causes an information processing apparatus to operate as
a real object detector that detects a real object,
a body part detector that detects a position and a pose of a part of a body, and
a drive signal generator that generates a drive signal on a basis of a positional relationship between the real object and the part, the drive signal being supplied to a tactile sense providing mechanism that is worn on the part.
